(19) United States
(12) Patent Application Publication
(10) Pub. No.: US 2011/0007835 A1
(43) Pub. Date: Jan. 13, 2011

(54) DIGITAL BROADCASTING TRANSMITTER, RECEIVER AND METHODS FOR PROCESSING STREAM THEREOF

(75) Inventors: Chan-sub Park, Incheon (KR); Kum-ran Ji, Seoul (KR); Yong-deok Chang, Suwon-si (KR); Hae-joo Jeong, Seoul (KR); Jung-pil Yu, Suwon-si (KR); Yong-sik Kwon, Seoul (KR)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS CO., LTD., Suwon-si (KR)

(21) Appl. No.: 12/667,327

(22) PCT Filed: Jun. 30, 2008
(86) PCT No.: PCT/KR2008/003862

§ 371 Date: Dec. 30, 2009

Related U.S. Application Data
(60) Provisional application No. 60/947,501, filed on Jul. 2, 2007.

(51) Int. Cl. H04L 27/00; H04L 27/06

(52) U.S. Cl. 375/295; 375/340

(57) ABSTRACT

A digital broadcasting transmitter includes a known data inserting unit which inserts a known data to a stream, and a trellis encoding unit which encodes the stream sequentially using a plurality of trellis encoders, wherein the known data inserting unit inserts the known data to the specific location of the stream, so that the known data may be trellis encoded by at least one specific trellis encoder.

### CROSS REFERENCE TO RELATED APPLICATIONS

This application is a National Stage of International Application No. PCT/KR2008/003862 filed Jun. 30, 2008 which claims priority to U.S. Provisional Patent Application No. 60/947,501 filed on Jul. 2, 2007, in the United States Patent and Trademark Office, the disclosures of both of which are incorporated herein in their entirety by reference.

### BACKGROUND

1. Technical Field

The apparatuses and methods consistent with the present invention relate to a digital broadcasting transmitter, a digital broadcasting receiver and methods for processing a stream thereof, and more particularly to a digital broadcasting transmitter and a digital broadcasting receiver which respectively transmit and receive a stream in which known data are dispersively distributed, and methods for processing the stream thereof.

2. Background Art

With the development of electronic and communication technologies, digital technologies have been introduced into the field of broadcasting systems, and diverse standards for digital broadcasting have been published. Specifically, there is the Advanced Television Systems Committee (ATSC) Vestigial Sideband (VSB) standard that is an American-type digital terrestrial broadcasting standard, and the Digital Video Broadcasting-Terrestrial (DVB-T) standard that is an European-type digital terrestrial broadcasting standard.

The ATSC VSB transmission method that is the American-type digital terrestrial broadcasting standard is based on a National Television System Committee (NTSC) frequency band, and is advantageous in implementing a transmitter and receiver easily and economically. Such an ATSC VSB transmission method uses a single carrier amplitude modulation vestigial side band (VSB), and is able to transmit high quality video, audio, and auxiliary data at a single 6 MHz bandwidth.

The digital broadcasting system can transmit and receive signals known by both a transmitting side and a receiving side, in order to improve the receiving performance of a stream. Such signals function as training symbols in the receiving side, and so may be used, for example, in demodulation, equalization, and error correction.

Such signals may be referred to as known data (supplementary reference sequence).

The known data may be included within the stream and then be transmitted together.

Meanwhile, such known data are known by both a transmitting side and a receiving side, so problems may arise if the data vary during processing. Also, even when the known data are concentrated excessively in a specific location of the stream, they may not properly function as a training symbol.

Accordingly, there is a need for technologies for effectively and stably processing the known data.

### SUMMARY

Apparatuses and methods consistent with the present invention provide a digital broadcasting transmitter which transmits a stream in which known data are dispersively distributed, a digital broadcasting receiver which receive and processes the transmitted stream, and methods for processing the stream thereof.

According to one aspect, exemplary embodiments provide a digital broadcasting transmitter including a known data inserting unit which inserts known data into a stream, and a trellis encoding unit which sequentially performs trellis encoding of the stream in which the known data is inserted using a plurality of trellis encoders. In this case, the known data inserting unit may insert the known data to the specific location of the stream in which at least one specific trellis encoder among the plurality of trellis encoders is to be processed.

The trellis encoding unit may use twelve sequentially operating trellis encoders, and the known data inserting unit may insert the known data at a preset section in order that the known data is repeatedly input to at least one preset trellis encoder among the twelve trellis encoders and is continuously trellis encoded.

The plurality of trellis encoders may each perform trellis encoding using a plurality of internal memories, and may initialize the internal memories to preset values before the trellis encoding of the known data is performed.

The digital broadcasting transmitter may further include an RS re-encoder which generates at least one new codeword corresponding to the initialization, and a multiplexer unit which corrects a stream using the generated codewords.

The digital broadcasting transmitter may further include a control unit which controls the insertion of the known data of the known data inserting unit according to known data information.

The digital broadcasting transmitter may further include a randomizing unit which randomizes a stream and provides it to the known data inserting unit, an RS encoding unit which performs RS encoding of the stream in which the known data is inserted by the known data inserting unit, an interleaving unit which interleaves the RS encoded stream and provides it to the trellis encoding unit, a multiplexer which adds a field synchronization signal and a segment synchronization signal to the stream output from the trellis encoding unit, and a modulating unit which modulates and outputs the stream output from the multiplexer.

The stream may include a normal data stream and at least one supplementary data stream processed robustly for error.

According to another aspect, exemplary embodiments provide a method for processing a stream of a digital broadcasting transmitter including inserting known data into a stream, and sequentially performing trellis encoding of the stream in which the known data is inserted using a plurality of trellis encoders. In this case, the known data may be inserted into a specific location of the stream on which at least one specific trellis encoder among the plurality of trellis encoders is to be processed.

The trellis encoding may be performed by twelve sequentially operating trellis encoders, and the known data may be inserted at a preset section in order that the known data is repeatedly input to at least one preset trellis encoder among the twelve trellis encoders and is continuously trellis encoded.

The method for processing the stream of the digital broadcasting transmitter may further include initializing internal memories provided in the plurality of trellis encoders to preset values before the trellis encoding of the known data is performed.

The method for processing the stream of the digital broadcasting transmitter may further include performing RS re-encoding, which generates new codewords corresponding to the initialization, and correcting the stream using the generated codewords.

The method for processing the stream of the digital broadcasting transmitter may further include randomizing a stream before the known data is inserted, performing RS encoding of the stream in which the known data is inserted, interleaving the RS encoded stream before the trellis encoding is performed, adding a field synchronization signal and a segment synchronization signal to the trellis encoded stream, and modulating and outputting the stream to which the field synchronization signal and the segment synchronization signal have been added.

The stream may include a normal data stream and at least one supplementary data stream processed robustly for error.

According to another aspect, exemplary embodiments provide a digital broadcasting receiver including a demodulating unit which performs demodulation of a stream in which known data are dispersively distributed, an equalizing unit which equalizes the demodulated stream, and a trellis decoding unit which performs trellis decoding of the equalized stream. In this case, the known data may be repeatedly input to at least one preset trellis encoder among a plurality of trellis encoders and may be continuously trellis encoded in a digital broadcasting transmitter which transmits the stream.

The digital broadcasting receiver may further include a known data detecting unit which detects information on the known data and provides it to at least one of the demodulating unit, the equalizing unit, and the trellis decoding unit.

The digital broadcasting receiver may further include a deinterleaving unit which deinterleaves the trellis decoded stream, an RS decoding unit which performs RS decoding of the deinterleaved stream, and a derandomizing unit which derandomizes the RS decoded stream.

The stream may include a normal data stream and a supplementary data stream processed robustly for error.

According to another aspect, exemplary embodiments provide a method for processing a stream of a digital broadcasting receiver including performing demodulation of a stream in which known data are dispersively distributed, performing equalization of the demodulated stream, and performing trellis decoding of the equalized stream. In this case, the known data may be repeatedly input to at least one preset trellis encoder among a plurality of trellis encoders and may be continuously trellis encoded in a digital broadcasting transmitter which transmits the stream.

At least one of the demodulation, the equalization, and the trellis decoding may be performed using the known data detected from the demodulated stream.

The stream may include a normal data stream and a supplementary data stream processed robustly for error.

With a digital broadcasting transmitter, a digital broadcasting receiver, and methods for processing a stream thereof according to the exemplary embodiments, known data are processed to be dispersively distributed. In particular, the known data are dispersively distributed in order that they may be continuously processed in at least one specific trellis encoder among a plurality of trellis encoders. The known data can thereby be effectively prevented from being excessively concentrated in a specific location or from being changed. Therefore, the known data can properly function as training symbols and can improve the performance of an equalizer in a digital broadcasting receiving system.

### BRIEF DESCRIPTION OF THE DRAWINGS

FIG. 1 is a block diagram showing a digital broadcasting transmitter according to an exemplary embodiment;

FIG. 2 is a block diagram showing an example of a constitution of a trellis encoding unit used in the digital broadcasting transmitter;

FIG. 3 is a block diagram showing an example of the detailed constitution of the digital broadcasting transmitter;

FIG. 4 illustrates an example of the stream constitution of the digital broadcasting transmitter;

FIG. 5 is a diagram showing the result of interleaving the stream of FIG. 4;

FIG. 6 illustrates another example of the stream constitution;

FIGS. 7 and 8 illustrate an example of a variety of examples of the insertion intervals of known data;

FIG. 9 is a flowchart for explaining a method for processing a stream of a digital broadcasting transmitter according to an exemplary embodiment;

FIG. 10 is a flowchart for explaining the processing of the stream of FIG. 9;

FIG. 11 is a block diagram showing a digital broadcasting receiver according to an exemplary embodiment;

FIG. 12 is a block diagram showing an example of the detailed constitution of the digital broadcasting receiver;

FIG. 13 is a flowchart for explaining a method for processing a stream of a digital broadcasting receiver according to an exemplary embodiment; and

FIGS. 14 to 16 illustrates an example of a variety of methods to insert a known data into a stream in the digital broadcasting transmitter.

### DESCRIPTION OF THE EXEMPLARY EMBODIMENTS

Hereinafter, exemplary embodiments of the present invention will be described with reference to the accompanying drawings.

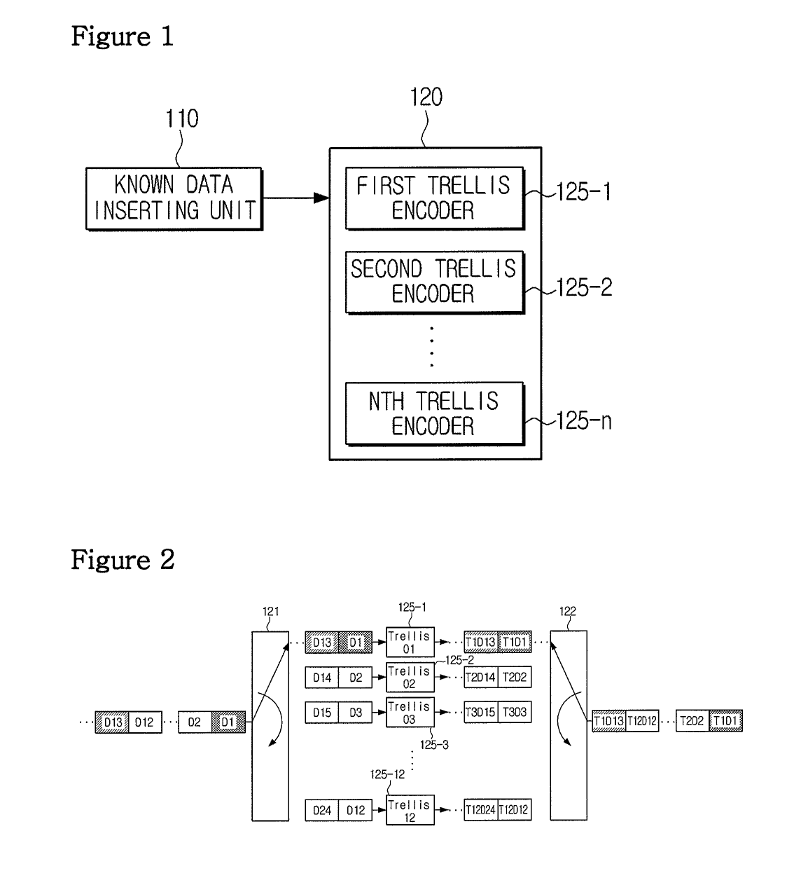

FIG. 1 is a block diagram showing a digital broadcasting transmitter according to an exemplary embodiment.

Referring to FIG. 1, the digital broadcasting transmitter includes a known data inserting unit 110 and a trellis encoding unit 120.

The known data inserting unit 110 inserts a known data into a stream. A known data means a data known by both a transmitting side and a receiving side. The known data may mean a supplementary reference signal or a supplementary reference sequence according to the standard used, and may be a training symbol or a training signal.

The trellis encoding unit 120 performs trellis encoding of the stream inserted with the known data.

In this case, the trellis encoding unit 120 may perform trellis encoding of the stream using a plurality of trellis encoders 125-1 to 125-n. More specifically, the trellis encoding unit may have the constitution of FIG. 2.

FIG. 2 is a block diagram showing an example of a constitution of a trellis encoding unit of the digital broadcasting transmitter.

Referring to FIG. 2, the trellis encoding unit 120 includes an input unit 121, a plurality of trellis encoders 125-1 to 125-12, and an output unit 122. From FIG. 2, it can be appreciated that there are twelve trellis encoders.

The input unit 121 divides a stream into predetermined units and then provides the units to the first to twelfth trellis encoders 125-1 to 125-12 sequentially.

The first to twelfth trellis encoders 125-1 to 125-12 each perform trellis encoding of the provided data, using a plurality of internal memories.

The output unit 122 collects the output of the first to twelfth trellis encoders 125-1 to 125-12 and outputs them to the back end of the trellis encoding unit 120. The input unit 121 and the output unit 122 may perform trellis encoding of the stream continuously by switching the first to twelfth trellis encoders 125-1 to 125-12 sequentially.

As described above, the trellis encoders use a plurality of internal memories, that is, shift registers, so previously processed data affect data processed later. In other words, the previously processed data are stored in the internal memory as they are, so actual data may change. In particular, this may cause a problem in known data known by both a receiving side and a transmitting side.

Accordingly, the trellis encoding unit 120 performs trellis resetting to initialize the internal memories to predetermined values, before the trellis encoding of the known data is performed. The trellis resetting may be performed in each of the first to twelfth trellis encoders 125-1 to 125-12.

Since the input unit 121 provides the stream by sequentially selecting the first to twelfth trellis encoders 125-1 to 125-12, the sort of data to be input to the first to twelfth trellis encoders 125-1 to 125-12 may change according to the order of arrangements of the data.

Taking this matter into consideration, the known data inserting unit 110 inserts the known data to the location of the stream, in which the known data is processed by a specific trellis encoder.

In other words, if the known data inserting unit 110 inserts the known data into each packet, there may be a section of the stream in which the known data is not present within one frame after being interleaved. If there is such a section in the stream, in which the known data is not present within one frame, as described above, performance of an equalizer on a receiving side may deteriorate, and functioning as a training symbol may not be performed properly as the known data are excessively concentrated on a predetermined section. In order to prevent this, the known data inserting unit 110 may insert one packet of the known data per a predetermined number of packet periods. The known data are thereby dispersively distributed through the stream. In particular, the known data inserting unit 110 may estimate a part of stream to be processed by the trellis encoder, and may insert the known data into the estimated location, taking interleaving rules into consideration.

In this case, the insertion location of the known data may be provided through a separate channel or may be determined by detecting the known data information from the stream. Accordingly, for the known data, only the specific trellis encoders may perform trellis encoding. In this case, the number of trellis encoders to process the known data may be determined optionally. In other words, the number may be determined to be only one of the twelve, to be any numbers within a range of two to eleven, or to be all twelve.

FIG. 2 shows an exemplary embodiment in which only a first trellis encoder of the plurality of trellis encoders 125-1 to 125-12 is used in processing the known data. In other words, when the stream is input to the trellis encoding unit 120 in the pattern of D1, D2, D3, . . . , D1, D2, D3, etc. are provided to the first to twelfth trellis encoders 125-1 to 125-12 sequentially using the input unit 121. If D12 is input to the twelfth trellis encoder 125-12, D13 is input again to the first trellis encoder 125-1.

Here, the known data is positioned only at the specific stream location, such as D1, D13, . . . etc. Accordingly, the known data such as D1 and D13 are continuously input to the first trellis encoder 125-1 and are trellis encoded. The part D1 of the known data corresponds to a starting location of the known data, so D1 is used for initialization of the first trellis encoder 125-1, that is, a trellis resetting.

If the data D1, D2, D3, . . . D12, D13, . . . processed by each trellis encoder 125-1 to 125-12 have reference numerals T1, T2, . . . T13, inserted using the numbers of the trellis encoders, the output unit 122 collects and outputs the data in the order T1D1, T2D2, T3D3, . . . , T1D13, T2D14, . . .

FIG. 2 shows the case in which only the first trellis encoder is used in processing the known data. However, a plurality of trellis encoders may be used. In particular, all the trellis encoders may be used in processing the known data. Description thereof will be omitted.

Information such as Program Specific Information Protocol (PSIP) Information may be additionally inserted into the stream. Therefore, when the known data are inserted at a predetermined period, the known data may be provided to a trellis encoder other than the intended trellis encoder. In order to prevent this, the known data inserting unit 100 may control the insertion locations of the known data properly and insert the known data to the locations at preset intervals.

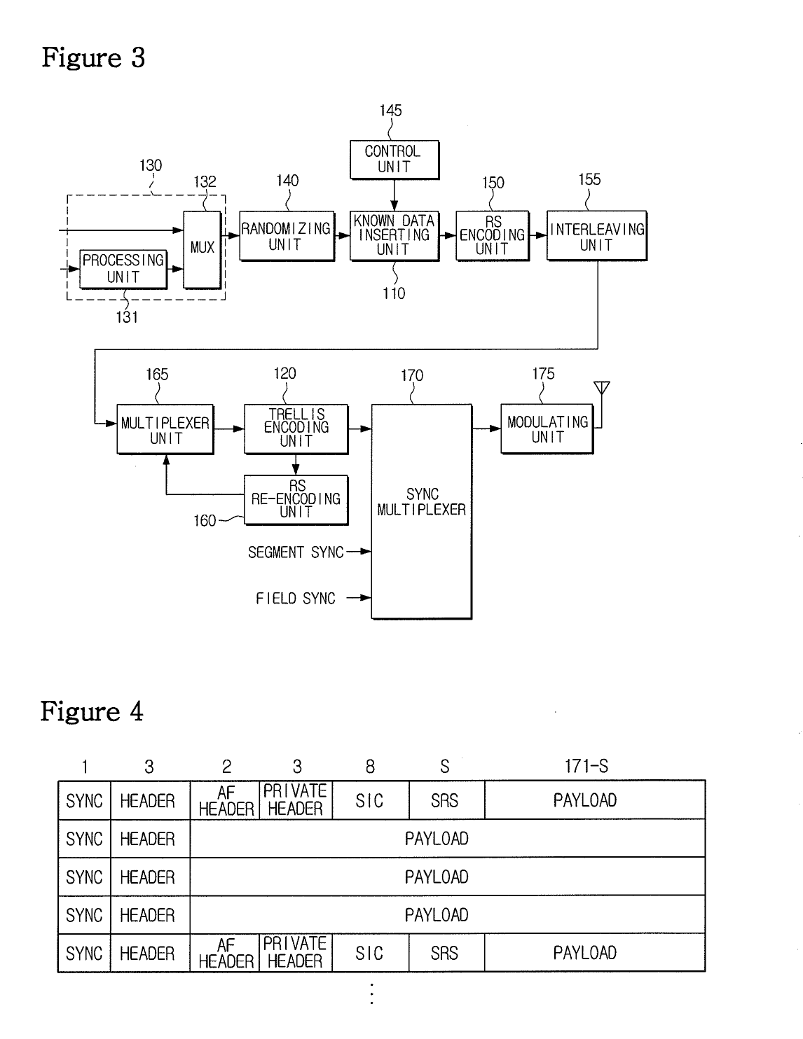

FIG. 3 is a block diagram showing an example of the detailed constitution of the digital broadcasting transmitter.

Referring to FIG. 3, the digital broadcasting transmitter may further include a stream constituting unit 130, a randomizing unit 140, a control unit 145, a Reed-Solomon (RS) encoding unit 150, an interleaving unit 155, an RS re-encoding unit 160, a multiplexer unit 165, a sync multiplexer 170, and a modulating unit 175, in addition to a known data inserting unit 110 and a trellis encoding unit 120.

The stream constituting unit 130 constitutes a stream to be transmitted. In this case, the stream constituting unit 130 may constitute the stream such that a supplementary data stream is inserted into an existing normal data stream. The supplementary data stream may be a stream to have enhanced robustness compared to the normal data stream.

More specifically, the stream constituting unit 130 may include a processing unit 131 and a MUX 132. The processing unit 131 receives the supplementary data stream and processes it to have the enhanced robustness. More specifically, the processing unit 131 may perform processing, such as RS encoding, interleaving or packet formatting, on the supplementary data stream.

The MUX 132 constitutes a stream in a manner of multiplexing the data stream output from the processing unit 131 with respect to a normal data stream.

The stream constituted by the stream constituting unit 130 is provided to the randomizing unit 140.

The randomizing unit 140 randomizes a stream and provides it to the known data inserting unit 110. In FIG. 3, the randomizing unit 140 is shown to be disposed at the back end of the stream constituting unit 130, however, the randomizing unit 140 may be disposed inside or at other locations relative to the stream constituting unit 130, or may be omitted.

The known data inserting unit 110 inserts known data into the randomized stream output from the randomizing unit 140. In this case, the known data inserting unit 110 may insert the known data into an adaptive field provided in the stream or may insert the known data into a packet data region. As described above, the known data inserting unit 110 may dispersively distribute the known data at appropriate locations and appropriate intervals, in order that the known data can be arranged on a location in which the known data is processed by at least one specific trellis encoder. By way of one example, the known data inserting unit 140 may insert the known data to only one packet per four packets (or two packets), or may insert the known data to all the packets or only some of the packets.

The inserting operations of the known data in the known data inserting unit 110 may be performed by a control signal output from the controller 145. The controller 145 extracts the known data information from the stream or receives the known data information through separate signaling, making it possible to control the inserting operations of the known data in the known data inserting unit 110.

The RS encoding unit 150 performs Reed-Solomon encoding of the stream output from the known data inserting unit 110. Each packet is added with a parity of 20 bytes for correcting errors by the RS encoding.

The interleaving unit 155 performs interleaving of the RS encoded stream output from the RS encoding unit 150.

The interleaved stream is provided to the multiplexer unit 165. The multiplexer unit 165 generally transmits the provided stream to the trellis encoding unit 120 as it is. When codewords of a stream change, the multiplexer unit 165 receives the changed codewords from the RS re-encoding unit 160, changes the stream and then provides the changed stream to the trellis encoding unit 120.

The trellis encoding unit 120 performs trellis encoding using a plurality of trellis encoders as described above. More specifically, the trellis encoding unit 120 may have a constitution of FIG. 2. The trellis encoding unit 120 also performs trellis resetting at appropriate time points. The trellis reset may be controlled by a reset signal provided by the controller 145 according to the known data information. In other words, if a reset signal is provided, each trellis encoder may initialize values pre-stored in internal memories to preset values.

Meanwhile, since the stream changes according to the initialization, all codewords may change. In other words, the RS encoding unit 150 adds a parity of 20 bytes to one stream unit (for example, of 187 bytes) to form one codeword. In such a condition, if the data within the stream is changed by the trellis reset, the data is not consistent with the parity. The RS re-encoding unit 160 changes the parity or the data by reflecting the data values at a point to be trellis reset, taking the matters described above into consideration, to generate new codewords. The data to be changed may be null data. The generated codewords are provided to the multiplexer unit 165, and the multiplexer unit 165 corrects the stream using the generated codewords.

The stream output from the trellis encoding unit 120 is provided to a sync multiplexer 170. The sync multiplexer 170 adds and outputs a segment sync and a field sync to the trellis encoded stream output from the trellis encoding unit 120.

The modulating unit 175 performs channel modulation and performs conversion of the multiplexed stream output from the sync multiplexer 170 into an RF channel band signal to transmit the converted signal. This is referred to as up-conversion. The stream up-converted by the modulating unit 175 is transmitted to a digital broadcasting receiver through a channel.

FIG. 4 shows an example of the stream constitution transmitted by a digital broadcasting transmitter. FIG. 4 illustrates an example of the case in which known data is implemented as a supplementary reference signal (SRS).

Referring to FIG. 4, a packet may comprise a 1-byte synchronization signal SYNC, a 3-byte header, and a 184-byte payload. If the packets of FIG. 4 go through the RS encoding unit 150, the packets have a constitution in which a parity of 20 bytes is added.

In FIG. 4, the known data is inserted to one packet per four packets by way of example, however, the insertion location of the known data and the number of the packets are not limited thereto.

FIG. 4 also shows a state in which the SRS, that is, the known data, is inserted into an adaptive field providing one packet per four packets. The adaptive field may comprise a 2-byte AF header, a 3-byte private header, an 8-byte Signaling Information Channel (SIC) region, and an S-byte known data inserting region. Such an adaptive field may be generated by an adapter unit (not shown) provided separately.

The private header is a header of private data. The private data that is optionally provided by a user (that is, a broadcasting provider) is written on the SIC region. The private header and the SIC region may be included in the adaptive field only when the private data intended to be transmitted exists.

As shown in the drawing, the adaptive field is formed in first and fifth packets, and a known data inserting unit 110 inserts a known data to the known data inserting region of the adaptive field generated in the first and fifth packets.

Second, third and fourth packets thereby have a 184-byte payload, but, the first and fifth packets have a 171-S byte payload, excluding the 2+3+8+S byte adaptive field.

In FIG. 4, the case in which the adaptive field is used is shown, but, the known data is not necessarily inserted into the adaptive field and may be inserted into the payload region itself. In other words, the known data inserting unit 110 inserts the known data into only the part that is processed by a specific trellis encoder and thereby allows the known data to be sequentially trellis encoded.

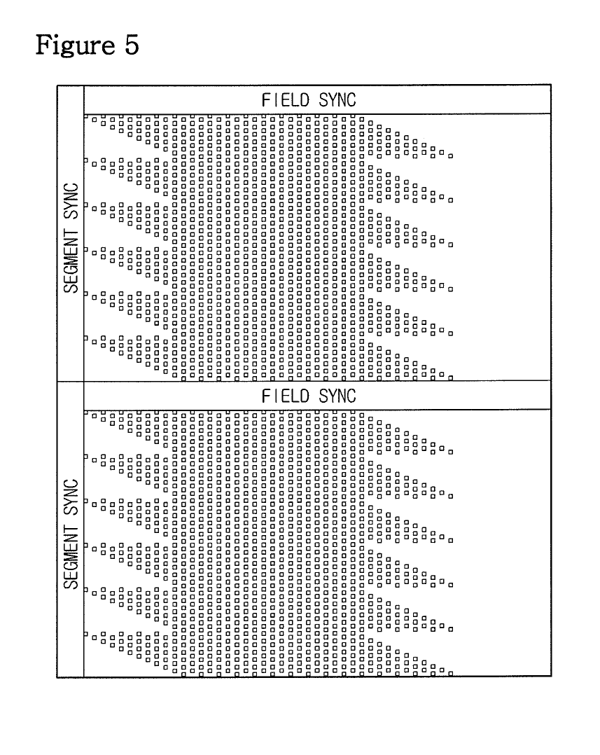

FIG. 5 is a diagram showing the result of interleaving the stream of FIG. 4.

If the stream of FIG. 4 is interleaved by an interleaving unit 155, the frame of FIG. 5 may be obtained. Referring to FIG. 5, it can be appreciated that there is no section that has no known data. In other words, the known data are evenly distributed throughout all sections of the frame used in the digital broadcasting transmitter.

As the known data are present on all segments, the known data can properly function as training symbols and can improve performance of an equalizer in the digital broadcasting system.

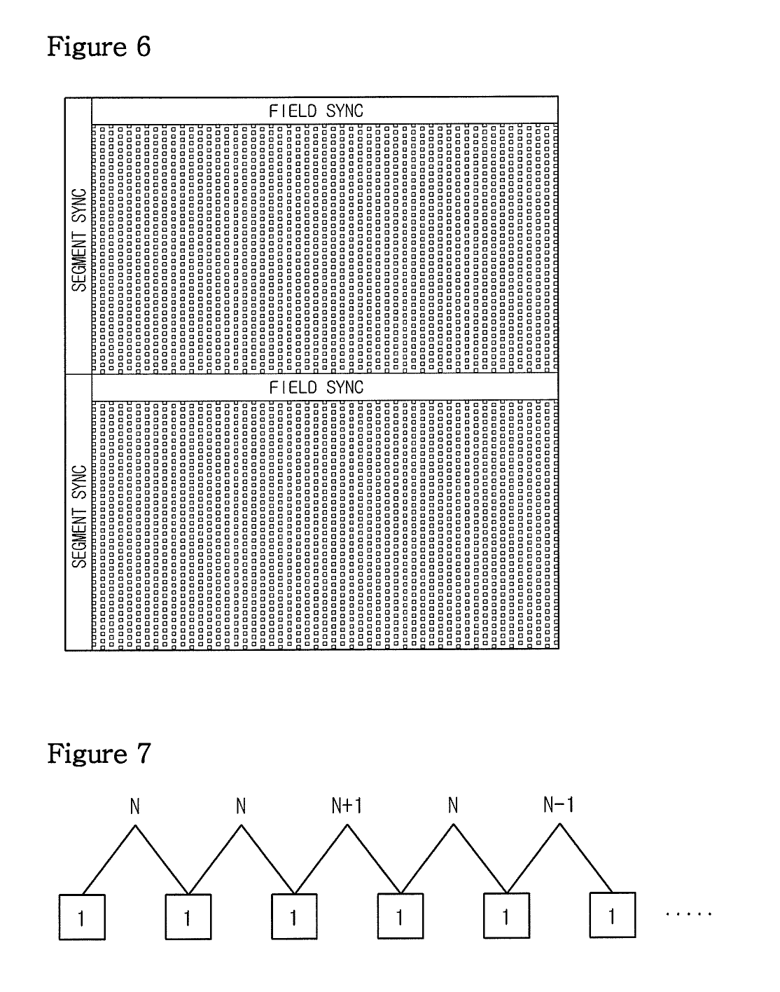

FIG. 6 illustrates another example of the result interleaving the stream. Referring to FIG. 6, known data are divided and inserted to various parts in order to be processed by a specific trellis encoder, so the known data are evenly distributed throughout the stream after interleaving.

As described above, the insertion location of the known data may be set properly in order that the known data can be processed only by one or more specific trellis encoder.

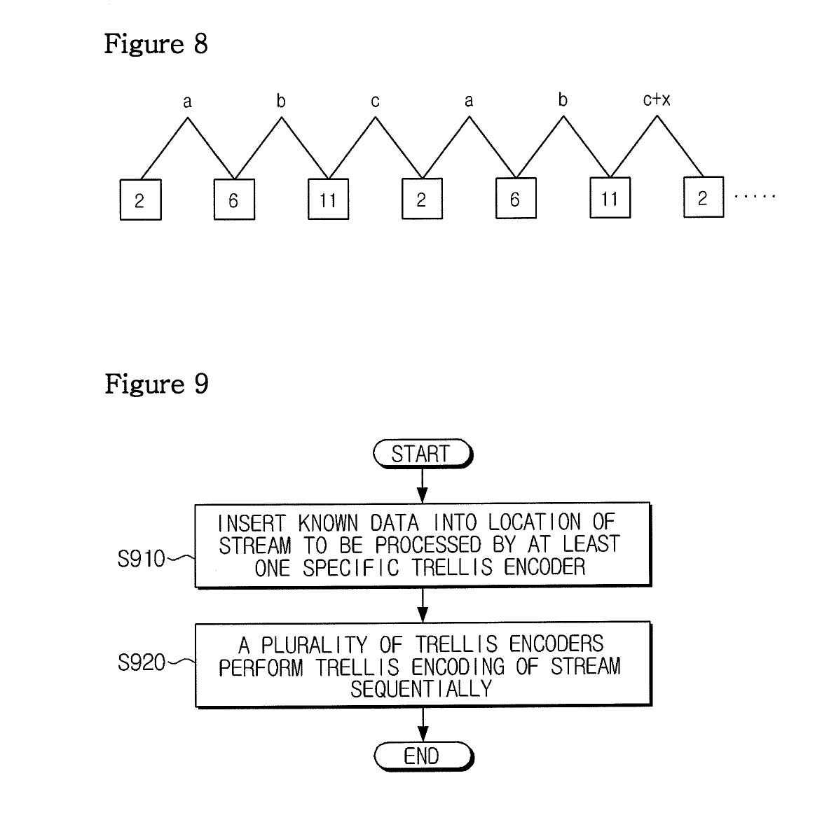

FIGS. 7 and 8 illustrate an example of a shape of known data dispersively distributed within a stream. In FIGS. 7 and 8, a square block represents the known data part, and the number in the square block represents the number of trellis encoder which processes the corresponding block.

FIG. 7 shows an exemplary embodiment in which only a first trellis encoder of a total of twelve trellis encoders is used in processing the known data, in the same manner as the exemplary embodiment of FIG. 2. Referring to FIG. 7, a known data inserting unit 110 may insert the known data in order that the known data can be dispersively arranged at appropriate intervals N, N+1, N−1. For example, when each trellis encoder performs trellis encoding of data in 1-byte units, the known data may be arranged by 1 byte every 12 bytes. That is, N may be 12.

Optional data such as program specific information may also be included within the stream, in addition to the broadcasting data such as a normal data stream or a supplementary data stream. In this case, if the known data is regularly inserted every 12 bytes, the trellis encoders which process the known data may change. Taking this matter into consideration, the arrangement locations of the known data may be flexibly determined at appropriate intervals, such as N−1 or N+1.

FIG. 8 shows an example in which the known data are processed by a plurality of trellis encoders. Referring to FIG. 8, the known data may be inserted into appropriate locations so that the known data should be trellis encoded by only second, sixth, and eleventh trellis encoders.

In this case, the arrangement intervals of the known data after interleaving may be generally maintained as a, b and c. However, when the optional data is inserted, the intervals may change, such as c+x. This feature may also, of course, be applied to a and b.

FIG. 9 is a flowchart for explaining a method for processing a stream of a digital broadcasting transmitter according to an exemplary embodiment of the present invention.

Referring to FIG. 9, the digital broadcasting transmitter inserts known data into a location of a stream, in which the known data is processed by at least one specific trellis encoder (S910). The insertion location of the known data may be determined, after considering all the factors such as the amount of known data, the insertion location or the amount of the optional data, the total number and the numbers of trellis encoders to process the known data, and interleaving rules. The known data described above may be inserted into an appropriate location by a control signal provided by a controller 145.

When the known data are inserted into the stream, the stream is sequentially trellis encoded using a plurality of trellis encoders (S920). As described above, the known data are dispersively distributed at a specific location within the stream, so one or a plurality of specific trellis encoders may perform trellis encoding of the known data continuously.

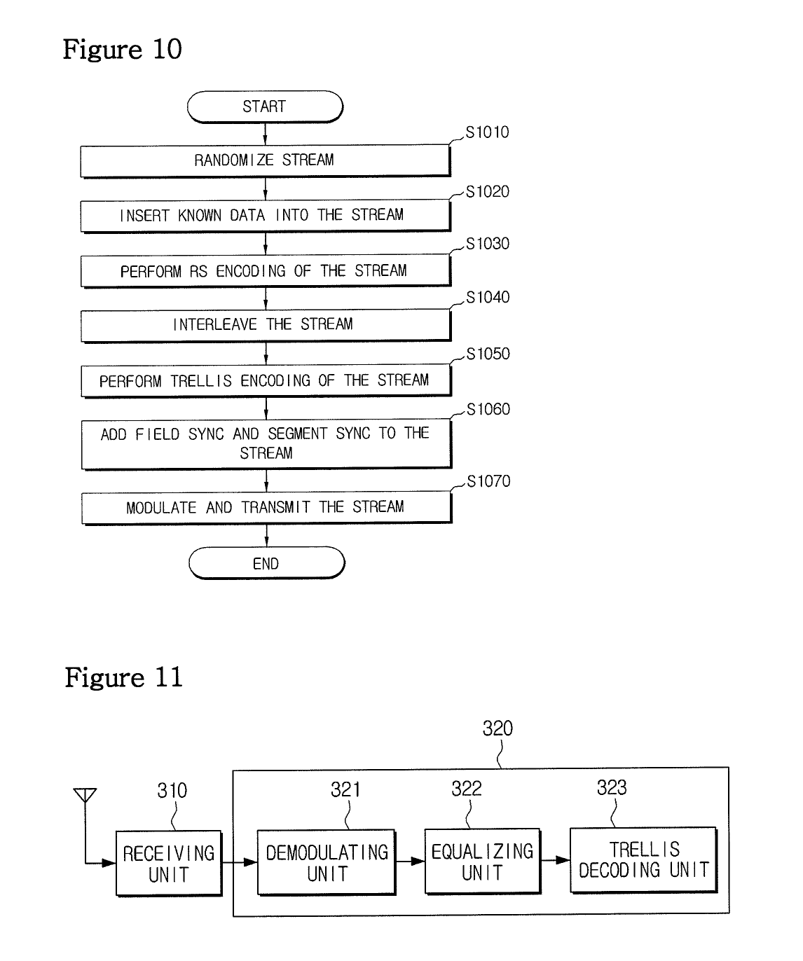

FIG. 10 is a flowchart for explaining the processing of the stream of FIG. 9 in more detail. Referring to FIG. 10, first, the stream is randomized (S1010), and known data are inserted to the randomized stream (S1020). Here, the insertion location of the known data may be appropriately controlled, as described above.

Next, the stream inserted with the known data is RS encoded (S1030), the RS encoded stream is interleaved (S1040), and the corresponding stream is trellis encoded using a plurality of trellis encoders (S1050).

Thereafter, segment synchronization signals and field synchronization signals are added to the stream (S1060), and the multiplexed stream is modulated and transmitted (S1070). The stream may be transmitted from the digital broadcasting transmitter to a digital broadcasting receiving system through the process described above.

FIG. 11 is a block diagram showing a digital broadcasting receiver according to an exemplary embodiment of the present invention.

Referring to FIG. 11, the digital broadcasting receiver includes a receiving unit 310, and a stream processing unit 320.

The receiving unit 310 receives a stream transmitted from a digital broadcasting transmitter. In other words, the receiving unit 310 receives the stream in which known data which are dispersively distributed at appropriate intervals are inserted. Therefore, the known data are trellis encoded continuously by at least one specific trellis encoder among a plurality trellis encoders provided on the digital broadcasting transmitter side.

The stream processing unit 320 processes the stream received by the receiving unit 310. More specifically, the stream processing unit 320 may include a demodulating unit 321, an equalizing unit 322, and a trellis decoding unit 323.

The demodulating unit 321 performs demodulation on the stream. The demodulation method of the stream corresponds to the modulation method of the digital broadcasting transmitter.

The equalizing unit 322 equalizes the demodulated stream. The equalizing unit 322 equalizes the demodulated stream output from the demodulating unit 321.

The demodulating unit 321 or the equalizing unit 322 may perform demodulation or equalization using the known data included in the stream.

The trellis decoding unit 322 performs trellis decoding of the equalized stream output by the equalizing unit 322. The trellis decoding operation of the trellis decoding unit 323 is the reverse of the operation of the trellis encoding unit 120 in the digital broadcasting transmitter.

The stream is appropriately processed through the constitution described above, so at least one of normal data and supplementary data may be restored normally.

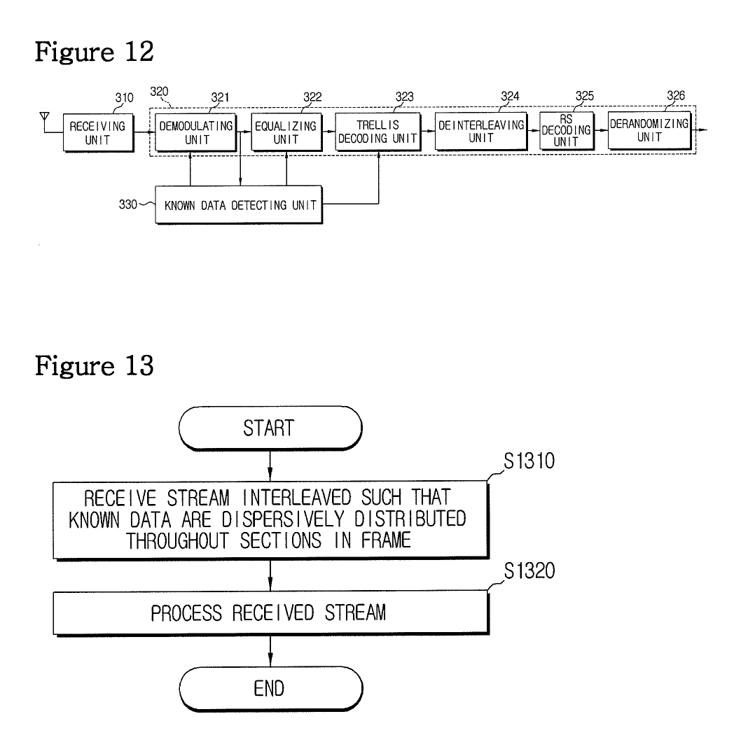

FIG. 12 is a block diagram showing an example of the detailed constitution of the digital broadcasting receiver. Referring to FIG. 12, a stream processing unit 320 may include a deinterleaving unit 324, an RS decoding unit 325, and derandomizing unit 326, in addition to a demodulating unit 321, an equalizing unit 322, and a trellis decoding unit 323. The digital broadcasting receiver may further include a known data detecting unit 330.

The deinterleaving unit 324 deinterleaves the trellis decoded stream output by the trellis decoding unit 323. The deinterleaving operation of the deinterleaving unit 324 is the reverse of the operation of the interleaving unit 155 in the digital broadcasting transmitter.

The RS decoding unit 325 performs RS decoding of the deinterleaved stream output from the deinterleaving unit 324. The RS decoding operation of the RS decoding unit 325 is the reverse of the operation of the RS encoding unit 150 in the digital broadcasting transmitter.

The derandomizing unit 326 performs derandomization of the RS decoded stream output by the RS decoding unit 325. The derandomization operation of the derandomizing unit 326 is the reverse of the operation of the randomizing unit 140 in the digital broadcasting transmitter.

The known data detecting unit 330 may detect information on the known data and may provide it to at least one of the demodulating unit 321, the equalizing unit 322, and the trellis decoding unit 333. The information on the known data may be included in the stream and may be provided through a separate channel. The known data detecting unit 330 may also detect and provide the known data itself.

Also, the respective constituents which constitute the digital broadcasting receiver of FIGS. 11 and 12 may be partially deleted according to the exemplary embodiment, their orders may be changed, or other constituents may further added. For example, the stream processing unit 320 may further include a decoder which processes a normal data stream and a demultiplexer.

FIG. 13 is a flowchart for explaining a method for processing a stream of a digital broadcasting receiver according to an exemplary embodiment.

The digital broadcasting receiver receives a stream transmitted from a digital broadcasting transmitter through a channel (S1310). In this case, the received stream has a shape in which known data are dispersively distributed throughout the stream. The known data is in a state in which they are continuously trellis encoded by a specific trellis encoder in the digital broadcasting transmitter.

The received stream described above is processed through processes of demodulation, equalization, and trellis decoding. The known data may be used in at least one of the demodulation, equalization, and trellis decoding, thereby making it possible to improve receiving performance.

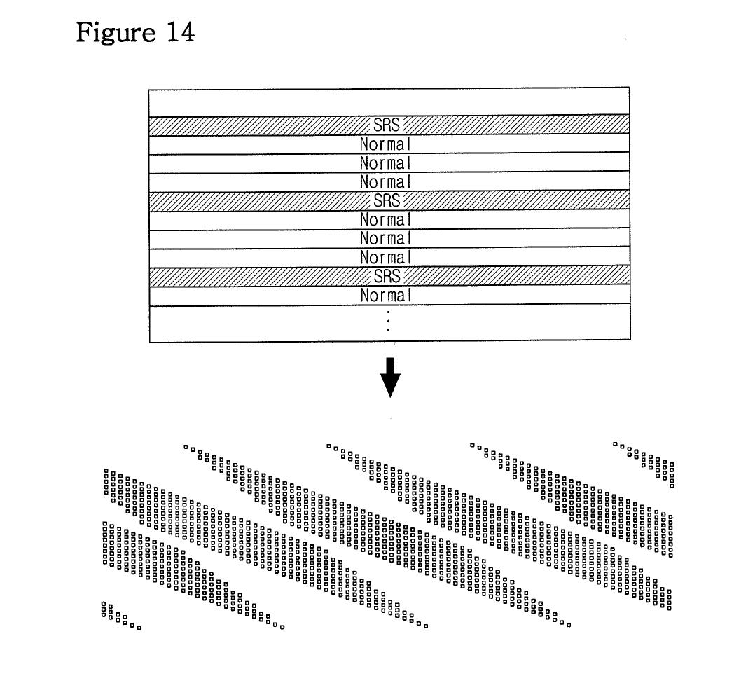

FIG. 14 illustrates an example of a constitution of a stream into which known data are appropriately inserted in order that the known data can be processed in at least one trellis encoder.

An upper portion of FIG. 14 illustrates the case in which a total of ten known data packets are inserted every four packets by a known data inserting unit 110. As shown in the upper portion of FIG. 14, the known data may be inserted into all parts of one packet. Only the normal and known data packets are shown in the upper portion of FIG. 14, but, supplementary data packets may also be present in addition to the normal data packets.

When ten known data packets are inserted as shown in the upper portion of FIG. 14, if interleaving is performed therein, the know data are dispersively distributed throughout the frame as shown in the lower portion of FIG. 14. Accordingly, the exemplary embodiments can be implemented so that a specific trellis encoder processes the known data.

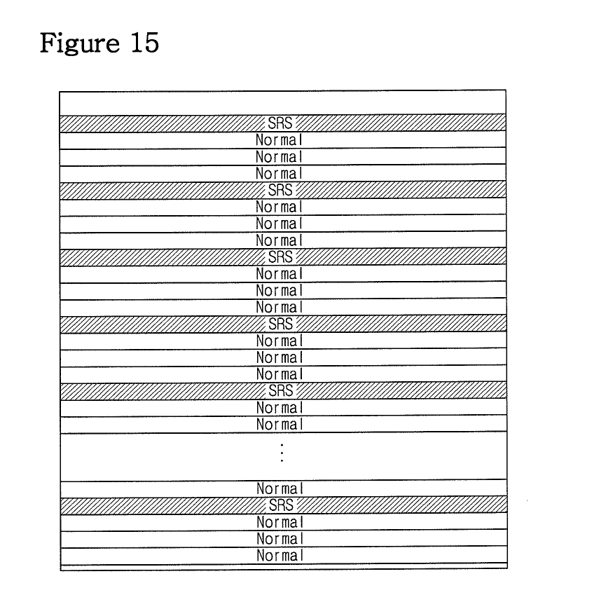

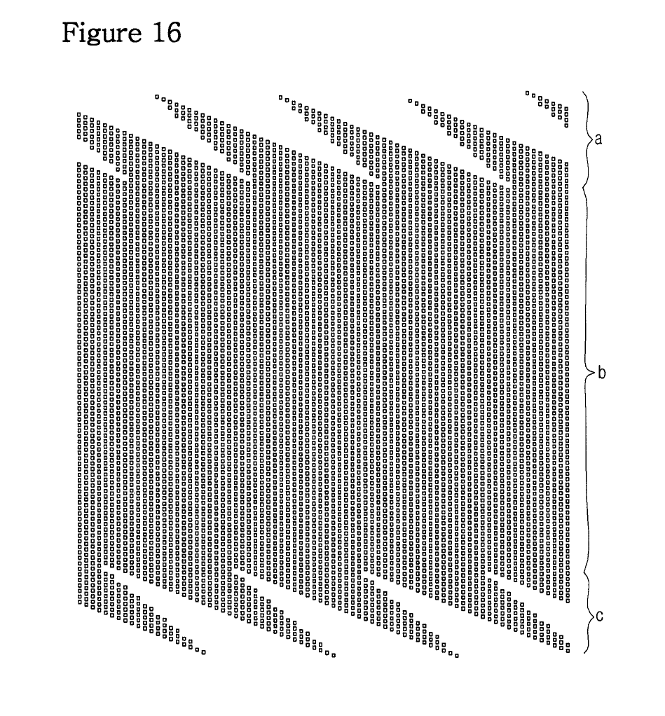

FIG. 15 illustrates the case in which a total of sixty known data packets are inserted every four packets, and FIG. 16 illustrates a constitution of stream after being interleaved.

Referring to FIG. 16, it can be appreciated that the known data are dispersively distributed throughout all regions in a predetermined section (b), and the known data are dispersively distributed in some other regions (a and c), thereby being represented in a horn shape.

As described above, the exemplary embodiments can be implemented so that at least one specific trellis encoder processes the known data continuously by appropriately adjusting the number of packets and insertion locations of the known data to be inserted.

Although a few exemplary embodiments have been shown and described, it would be appreciated by those skilled in the art that changes may be made in these exemplary embodiments without departing from the principles and spirit of the invention, the scope of which is defined in the claims and their equivalents.

1. A digital broadcasting transmitter, comprising:
a known data inserting unit which inserts known data into a stream; and
a trellis encoding unit which sequentially performs trellis encoding of the stream in which the known data are inserted using a plurality of trellis encoders,
wherein the known data inserting unit inserts the known data to the specific location of the stream on which at least one specific trellis encoder among the plurality of trellis encoders is to be processed.

2. The digital broadcasting transmitter of claim 1, wherein the trellis encoding unit uses twelve sequentially operating trellis encoders, and the known data inserting unit inserts the known data at a preset section in order that the known data is repeatedly input to at least one preset trellis encoder among the twelve trellis encoders and is continuously trellis encoded.

3. The digital broadcasting transmitter of claim 1, wherein the plurality of trellis encoders perform each trellis encoding using a plurality of internal memories, and -initializes the internal memories to preset values before the trellis encoding of the known data is performed.

4. The digital broadcasting transmitter of claim 3, further comprising:
an RS re-encoder which generates at least one codeword corresponding to the initialization; and
a multiplexer unit which corrects a stream using the generated codewords.

5. The digital broadcasting transmitter of claim 1, further comprising a control unit which controls the insertion of the known data of the known data inserting unit according to known data information.

6. The digital broadcasting transmitter of claim 1, further comprising:
a randomizing unit which randomizes a stream and provides it to the known data inserting unit;
an RS encoding unit which performs RS encoding of the stream in which the known data is inserted by the known data inserting unit;
an interleaving unit which interleaves the RS encoded stream and provides the RS encoded stream to the trellis encoding unit;
a multiplexer which adds a field synchronization signal and a segment synchronization signal to a stream output from the trellis encoding unit; and
a modulating unit which modulates and outputs a stream output from the multiplexer.

7. The digital broadcasting transmitter of claim 1, wherein the stream includes a normal data stream and at least one supplementary data stream processed robustly for error.

8. A method for processing a stream of a digital broadcasting transmitter, the method comprising:
inserting known data into a stream; and
sequentially performing trellis encoding of the stream in which the known data is inserted using a plurality of trellis encoders,
wherein the known data is inserted into a specific location of the stream on which at least one specific trellis encoder among the plurality of trellis encoders is to be processed.

9. The method for processing the stream of claim 8, wherein the trellis encoding is performed by twelve sequentially operating twelve trellis encoders, and the known data is inserted at a preset section in order that the known data is repeatedly input to at least one preset trellis encoder among the twelve trellis encoders and is continuously trellis encoded.

10. The method for processing the stream of claim 8, further comprising initializing internal memories provided in the plurality of trellis encoders to preset values before the trellis encoding of the known data is performed.

11. The method for processing the stream of claim 8, further comprising:
performing RS re-encoding, which generates new codewords corresponding to the initialization; and
correcting the stream using the generated codewords.

12. The method for processing the stream of claim 8, further comprising:
randomizing a stream before the known data is inserted;
performing RS encoding of the stream in which the known data is inserted; interleaving the RS encoded stream before the trellis encoding is performed;
adding a field synchronization signal and a segment synchronization signal to the trellis encoded stream; and
modulating and outputting the stream to which the field synchronization signal and the segment synchronization signal are added.

13. The method for processing the stream of claim 8, wherein the stream includes a normal data stream and at least one supplementary data stream processed robustly for error.

14. A digital broadcasting receiver, comprising:
a demodulating unit which performs demodulation of a stream in which known data are dispersively distributed;
an equalizing unit which equalizes the demodulated stream; and
a trellis decoding unit which performs trellis decoding of the equalized stream,
wherein the known data are repeatedly input to at least one preset trellis encoder among a plurality of trellis encoders and are continuously trellis encoded by a digital broadcasting transmitter which transmits the stream.

15. The digital broadcasting receiver of claim 14, further comprising a known data detecting unit which detects information on the known data and provides it to at least one of the demodulating unit, the equalizing unit, and the trellis decoding unit.

16. The digital broadcasting receiver of claim 14, further comprising:
a deinterleaving unit which deinterleaves the trellis decoded stream;
an RS decoding unit which performs RS decoding of the deinterleaved stream; and
a derandomizing unit which derandomizes the RS decoded stream.

17. The digital broadcasting receiver of claim 14, wherein the stream includes a normal data stream and a supplementary data stream processed robustly for error.

18. A method for processing a stream of a digital broadcasting receiver, the method comprising:
performing demodulation of a stream in which known data are dispersively distributed;
performing equalization of the demodulated stream; and
performing trellis decoding of the equalized stream,
wherein, the known data are repeatedly input to at least one preset trellis encoder among a plurality of trellis encoders and are continuously trellis encoded in a digital broadcasting transmitter which transmits the stream.

19. The method for processing the stream of claim 18, wherein at least one of the demodulation, the equalization, and the trellis decoding is performed using the known data detected from the demodulated stream.

20. The method for processing the stream of claims 18, wherein the stream includes a normal data stream and a supplementary data stream processed robustly for error.
